(19) United States
(12) Patent Application Publication
(10) Pub. No.: US 2005/0099114 A1
(43) Pub. Date: May 12, 2005

(54) Organic electroluminescent panel and method for manufacturing the panel

(76) Inventors: Chao-Chin Wu, Taipei (TW); Chia-Chieh Hsiao, Shulin City (TW)

Correspondence Address: BIRCH STEWART KOLASCH & BIRCH, PO BOX 747, FALLS CHURCH, VA, 22040-0747, US

(21) Appl. No.: 10/704,626

(22) Filed: Nov. 12, 2003

(51) Int. Cl. H05B 33/00

(52) U.S. Cl. 313/504; 313/506

(57) ABSTRACT

An organic electroluminescent panel includes a plurality of pixels disposed on a substrate. The pixel comprises an organic electroluminescent device, at least one pixel-defining layer, and at least one separator. The organic electroluminescent device comprises, in sequence, a first electrode, at least one organic functional layer, and a second electrode. The first electrode is disposed on the substrate. The pixel-defining layer is disposed on the first electrode or on the substrate. The separator is disposed on the pixel-defining layer. The organic functional layer is disposed on the first electrode or on the separator. The second electrode is disposed on the organic functional layer. In this case, the pixel-defining layer and the separator are made of negative photoresist. Furthermore, a method for manufacturing the organic electroluminescent panel is disclosed.

### BACKGROUND OF THE INVENTION

1. Field of Invention

The invention relates to a panel and its manufacturing method and, in particular, to an organic electroluminescent panel and manufacturing method thereof.

2. Related Art

Information communication has become one of the most important industries. In particular, the portable communication displaying products are the key point of development. In such products, the development of the flat-panel display, which is the communication interface between human beings and information, is particularly important. At present time, the technologies applied to the flat-panel displays include plasma displays, liquid crystal displays, inorganic electroluminescent displays, light emitting diodes, vacuum fluorescence displays, field emission displays, electro-chromic displays and so on.

Comparing to other flat-panel displays, the organic electroluminescent panel possesses the advantages of self-emission, full viewing angle, power saving, simple manufacturing process, low cost, wide operation temperature, fast response rate, and full color, which make it have great potential to become the leading role of the flat-panel displays.

Organic electroluminescent panel includes a plurality of organic electroluminescent devices. The organic electroluminescent device uses the self-emission character of an organic functional material to achieve the object of displaying. The structure of the organic electroluminescent device includes a pair of electrodes and an organic functional material sandwiched in between the electrodes. When applying a current to the electrodes, holes are injected from a first electrode and electrons are injected from a second electrode, repectively. While applying a voltage or a current, the holes and electrons are moved in the organic functional layer, and are recombined to generate excitons. The excitons can excite materials of the organic functional layer, so that the excited materials emit light to release energy.

FIG. 1 is a perspective view of a conventional organic electroluminescent panel. The device is fabricated by laminating sequentially on a transparent glass substrate 1, an anode 2 formed of a multiple of transparent electrodes, an isolation layer 3, an organic functional layer 4, a cathode 5 which constitutes upper electrodes orthogonal to the transparent electrodes.

For avoiding the short-circuiting of an anode with a cathode, referring to FIG. 2, Japanese Unexamined Patent Publication No. H8-315981 discloses a series of pixel-defining layer 3′ are formed on a substrate having anodes. On each of the pixel-defining layer 3′, there is an overhanging portion, called separator 31. Note that the pixel-defining layers 3′ are photoresist made of, such as, polyimide, and the separator 31 is made of SiO₂. The pixel-defining layer 3′ has on its top an overhanging separator 31, protruding in the direction parallel to the substrate surface. After the formation of the pixel-defining layer 3′, an organic functional layer 4 and a cathode 5 are formed in order. The cathode is separated by the pixel-defining layer 3′ and separator 31 and the electrodes at both sides of the isolation layer are electrically insulated from each other. In this method, short circuit of an anode and a cathode, specifically short circuit at a cathode edge, is avoided but a peeling off issue of separators is happened.

Hence, U.S. Pat. No. 6,570,323 discloses a method for fabricating the pixel-defining layers and the separators of the organic electroluminescent device to solve the peeling off issues of separators. In this case, note that the pixel-defining layer of Si₃N₄ or SiO₂ is formed by means of PECVD on the substrate patterned with the first electrode strips of ITO, and is then patterned by photolithography. After that, a photoresist film is coated, exposed and developed, so that the separators are formed to overlay on the pixel-defining layers.

However, the pixel-defining layer and the separators are made of different kind of material, so there are some problems in the manufacturing processes. Firstly, there are two hard baking processes after patterning, and, as a result, the positions of separators disposed on the pixel-defining layer are easily shifting and have some misalignment problems. Second, because the property difference of the materials, the adhesion force between the pixel-defining layer and the separator are poor. After used for a certain of time, product deteriorations, even peeling off, occur in the bonding place between the pixel-defining layer and the separator, resulting in low product reliability. Both of the problems are the bottlenecks for improving yield of the manufacturing process.

As described above, it is an important subjective to provide a method for manufacturing an organic electroluminescent panel for solving the above-mentioned problems.

### SUMMARY OF THE INVENTION

In view of the foregoing, this invention is to provide an organic electroluminescent panel and method for manufacturing the panel, which can prevent the positions of separators from shifting and prevent the separators peeling off from the pixel-defining layers.

To solve the above-mentioned problems, an organic electroluminescent panel of this invention includes a plurality of pixels disposed on a substrate. The pixel comprises an organic electroluminescent device, at least one pixel-defining layer, and at least one separator. The organic electroluminescent device comprises, in sequence, a first electrode, at least one organic functional layer, and a second electrode. The first electrode is disposed on the substrate. The pixel-defining layer is disposed on the first electrode or on the substrate. The separator is disposed on the pixel-defining layer. The organic functional layer is disposed on the first electrode or on the separator. The second electrode is disposed on the organic functional layer. Wherein the pixel-defining layer and separator are made of negative photoresist.

The invention further provides a method for manufacturing an organic electroluminescent panel. The method at least comprises processes as following: providing a substrate with at least one first electrode thereon; coating a first negative photoresist layer on the substrate having a strip of the first electrode; exposing the first negative photoresist layer; coating a second negative photoresist layer on the first negative photoresist layer; exposing the second negative photoresist layer; developing the first negative photoresist layer and the second negative photoresist layer to form at least one pixel-defining layer and at least one separator, wherein at least a portion of the pixel-defining layer and the first electrode are intersected and the separator is formed on the pixel-defining layer; depositing at least one organic functional layer on the first electrode; and depositing at least one second electrode on the organic functional layer.

As mentioned above, the pixel-defining layer and the separator are made of negative photoresist, so layer shifting and peeling off between the pixel-defining layer and the separator can be prevented. Therefore, the invention can avoid the problems caused by the different materials and improve the reliability of products.

### BRIEF DESCRIPTION OF THE DRAWINGS

The invention will become more fully understood from the detailed description given herein below illustrations only, and thus is not limitative of the present invention, and wherein:

FIG. 1 is a schematic three-dimensional view of the conventional organic electroluminescent panel;

FIG. 2 is a schematic cross-sectional view of another conventional organic electroluminescent panel;

FIG. 3 is a schematic three-dimensional view of the organic electroluminescent device according to a preferred embodiment of the invention;

FIG. 4 is a flow chart of the method for manufacturing an organic electroluminescent device according to a preferred embodiment of the invention;

FIG. 5 is a flow chart of a pixel-defining layer and separator forming process of the method for manufacturing an organic electroluminescent device of FIG. 4;

FIG. 6 is a flow chart of another pixel-defining layer and separator forming process of the method for manufacturing an organic electroluminescent device of FIG. 4; and

FIG. 7 is a flow chart of a method for manufacturing an organic electroluminescent device according to another preferred embodiment of the invention.

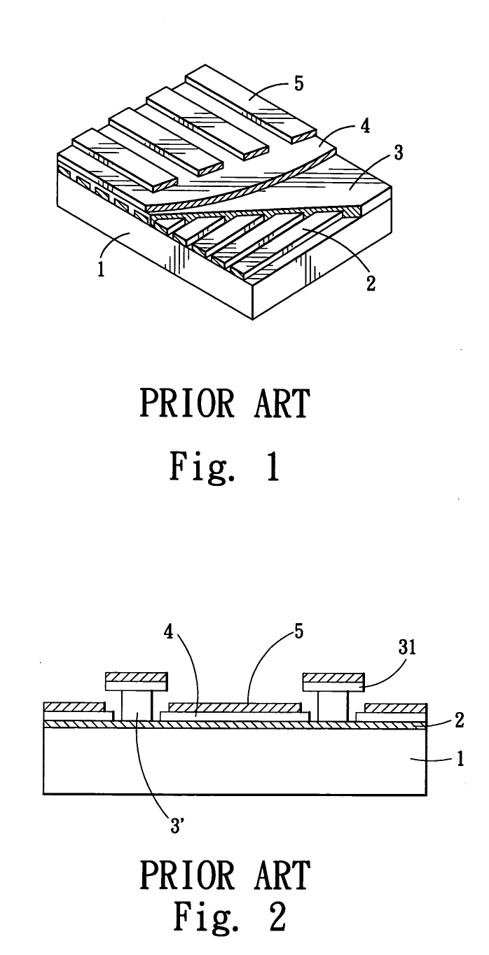

### DETAILED DESCRIPTION OF THE INVENTION

The organic electroluminescent panel and method for manufacturing the panel according to preferred embodiments of the invention will be described herein below with reference to the accompanying drawings, wherein the same reference numbers refer to the same elements.

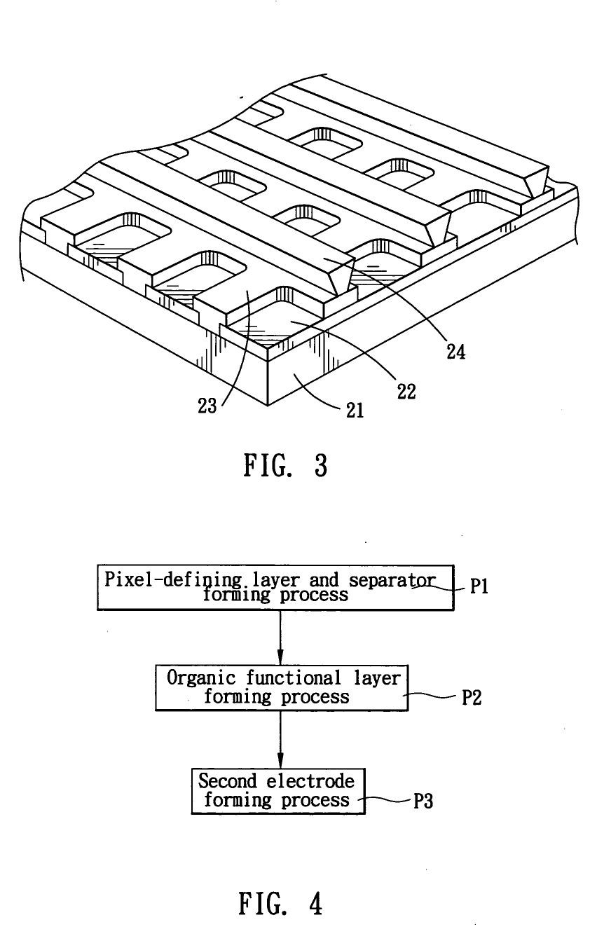

Referring to FIG. 3, an organic electroluminescent panel according to a preferred embodiment of the invention includes a plurality of pixels disposed on a substrate 21. The pixel comprises an organic electroluminescent device, at least one pixel-defining layer 23, and at least one separator 24. The organic electroluminescent device comprises, in sequence, a first electrode 22, at least one organic functional layer (not shown), and a second electrodes (not shown).

In the current embodiment, the substrate 21 is a transparent substrate, which can be a glass substrate, a plastic substrate, or a flexible substrate. In particular, the flexible substrate or plastic substrate can be made of polycarbonate (PC), polyester (PET), cyclic olefin copolymer (COC), metallocene-based cyclic olefin copolymer (mCOC), or a thin glass.

The first electrodes 22, which are transparent electrodes, are disposed on the substrate 21. In the current embodiment, the first electrodes 22 are disposed on the substrate 21 by way of sputtering or ion plating. The first electrodes 22 are made of a conductive metal oxide, such as indium-tin oxide (ITO), aluminum-zinc oxide (AZO), or indium-zinc oxide (IZO) and have a thickness of above 500 Å.

The pixel-defining layers 23 are disposed on the first electrode 22 or on the substrate 21, and at least a portion of pixel-defining layers 23 and first electrodes 22 are intersected so as to form a plurality of pixels. The separators 24 are disposed respectively on the pixel-defining layers 23 for separating the second electrodes disposed in the pixels. In this embodiment, the pixel-defining layers 23 and the separators 24 can be made of any kind of negative photoresist, such as polyimide, propylene glycol monomethyl ether acetate, novolak resin, polyhydroxy styrene type resin or the mixture of photoacid generator and crosslinking agent. The developer used in the consequent development process is basic.

The organic functional layer is disposed on the first electrode 22. The second electrodes are disposed on the organic functional layer. The second electrodes are formed on the substrate via evaporization or sputtering. In addition, the materials of the second electrode include but not limited to Al, Ca, Mg, In, Sn, Mn, Ag, Au and Magnesium alloy such as Mg:Ag, Mg:In, Mg:Sn, Mg:Sb and Mg:Te, etc.

Besides, the organic electroluminescent panel of the invention can further include a package component (not shown), which is disposed on the substrate 21 to encapsulate the first electrodes 22, the pixel-defining layers 23, the separators 24, the organic functional layers, and the second electrodes.

The method for manufacturing an organic electroluminescent panel according to a preferred embodiment of the invention is described herein below with reference to FIG. 4 to FIG. 7.

As shown in the FIG. 4, the method for manufacturing an organic electroluminescent panel includes a pixel-defining layer and separator forming process P1, an organic functional layer forming process P2, and a second electrode forming process P3.

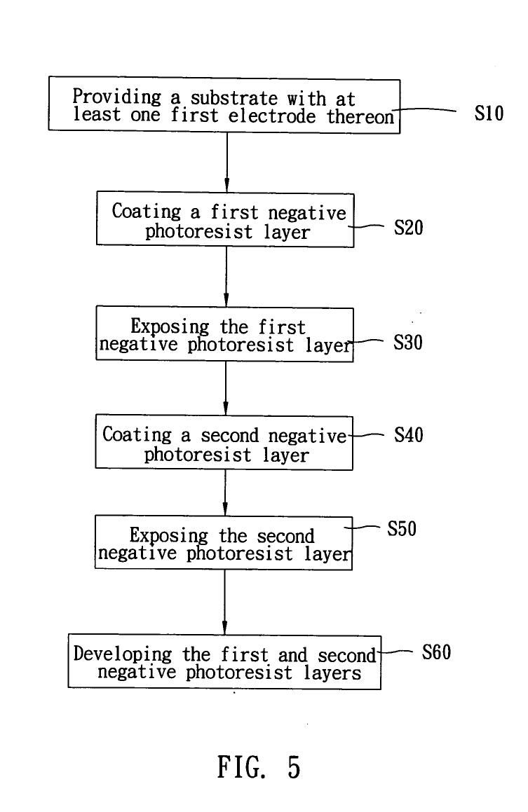

The pixel-defining layer and separator forming process P1, as shown in FIG. 5, includes following steps of: providing a substrate with at least one first electrode disposed thereon (S10), coating a first negative photoresist layer on the substrate having a strip of the first electrode (S20), exposing the first negative photoresist layer (S30), coating a second negative photoresist layer on the first negative photoresist layer (S40), exposing the second negative photoresist layer (S50), and developing the first and the second negative photoresist layers to form at least one pixel-defining layer and separator (S60). In the process P1, the resultant structure consisting of a plurality of pixel-defining layers and separators, which are the developed first photoresist layer and the developed second photoresist layer formed on the first electrode.

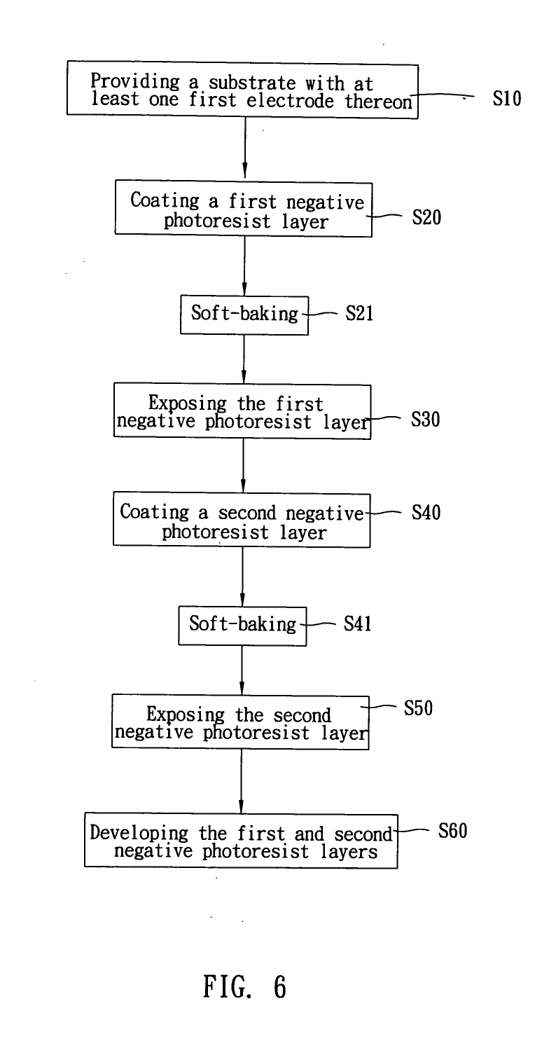

Referring to FIG. 6, the pixel-defining layer and separator forming process P1 may further include a soft baking treatment (S21) for the first negative photoresist layer after forming the first negative photoresist layer and a soft baking treatment (S41) for the second negative photoresist layer after forming the second negative photoresist layer. Thus, the solidification of the first negative photoresist layer and second negative photoresist layer is speeded.

The organic functional layer forming process P2 depositing an organic functional layer on the first electrode. In the second electrode forming process P3, a second electrode is deposited on the organic functional layer and between the two separators.

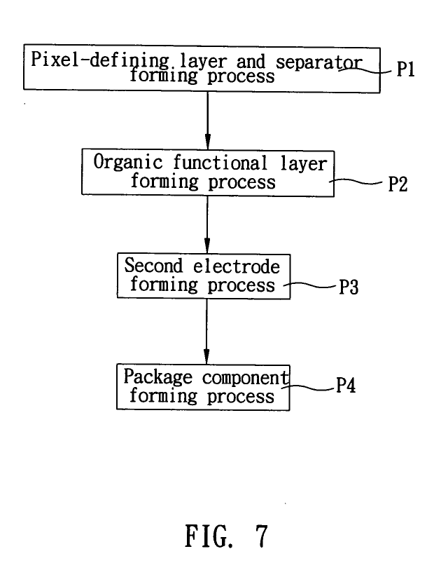

Moreover, as shown in FIG. 7, the method for manufacturing an organic electroluminescent panel further includes a package component forming process P4. In the package component forming process P4, a package component is closely formed on the substrate and encapsulates up the first electrode, the pixel-defining layers, the separators, the organic functional layer and the second electrode.

As mentioned above, because the pixel-defining layers and the separators are made of negative photoresist, during the hard baking process, there will not be any shift, which happened in the prior art due to the different thermal expansion coefficients. Moreover, in the present invention, the pixel-defining layers and the separators are made of negative photoresist, so the adhesion force between them is stronger. Comparing to the conventional methods for forming the pixel-defining layer and the separator with different kind of materials, the invention has better product reliability. Furthermore, when forming the pixel-defining layers and the separators by negative photoresist, only one development process is required. Thus, the clean step before forming the negative photoresist of the prior art is also omitted. This invention not only can simplify the manufacturing processes, but also reduce the contamination of the environment.

As a result, the invention not only can resolve the problems existing in the prior art, but also can reduce the steps and the cost of the manufacturing process. The invention also has the benefit of environment protecting.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. An organic electroluminescent panel, comprising:
a plurality of pixels disposed on a substrate;
the pixel comprises an organic electroluminescent device, at least one pixel-defining layer, and at least one separator; and
the organic electroluminescent device comprises, in sequence, a first electrode, at least one organic functional layer, and a second electrode;
wherein the first electrode is disposed on the substrate, the pixel-defining layer is disposed on the first electrode or on the substrate, the separator is disposed on the pixel-defining layer, the organic functional layer is disposed on the first electrode or on the separator; wherein the pixel-defining layer and the separator are made of negative photoresist.

2. The organic electroluminescent panel of claim 1, further comprising
a package component disposed on the substrate to encapsulate the first electrode, the pixel-defining layer, the separator, the organic functional layer and the second electrode.

3. The organic electroluminescent panel of claim 1, wherein the substrate is at least one selected from the group consisting of glass substrate, plastic substrate, and flexible substrate.

4. The organic electroluminescent panel of claim 1, wherein the first electrode is a conductive metal oxide electrode.

5. The organic electroluminescent panel of claim 4, wherein the conductive metal oxide electrode is at least one selected form the group consisting of indium tin oxide, indium zinc oxide, and aluminum zinc oxide.

6. The organic electroluminescent panel of claim 1, wherein the material of the second electrode is at least one selected from the group consisting of Al, Ca, Mg, In, Sn, Mn, Ag, Au and Magnesium alloy.

7. The organic electroluminescent panel of claim 6, wherein the Magnesium alloy included but not limited to Mg:Ag, Mg:In, Mg:Sn, Mg:Sb and Mg:Te.

8. The organic electroluminescent panel of claim 1, wherein the pixel-defining layer and the separator are made of the same kind of material.

9. The organic electroluminescent panel of claim 1, wherein the negative photoresist is polyimide, propylene glycol monomethyl ether acetate, novolak resin, polyhydroxy styrene type resin or the mixture of photoacid generator and crosslinking agent.

10. A method for manufacturing an organic electroluminescent panel, at least comprising:
providing a substrate with at least one first electrode thereon;
coating a first negative photoresist layer on the substrate having a strip of the first electrode;
exposing the first negative photoresist layer;
coating a second negative photoresist layer on the first negative photoresist layer;
exposing the second negative photoresist layer;
developing the first negative photoresist layer and the second negative photoresist layer to form at least one pixel-defining layer and a separator, wherein at least a portion of the pixel-defining layer and the first electrode are intersected and the separator is formed on the pixel-defining layer;
depositing at least one organic functional layer on the first electrode or on the separator; and
depositing at least one second electrode on the organic functional layer.

11. The method of claim 10, further comprising
forming a package component on the substrate, wherein the package component encapsulates the first electrode, the pixel-defining layer, the separator, the organic functional layer, and the second electrode.

12. The method of claim 10, further comprising:
soft baking the first negative photoresist layer after the first negative photoresist layer is coated.

13. The method of claim 10, further comprising:
soft baking the second negative photoresist layer after the second negative photoresist layer is coated.

14. The method of claim 10, wherein the substrate is at least one selected from the group consisting of glass substrate, plastic substrate, and flexible substrate.

15. The method of claim 10, wherein the first electrode is a conductive metal oxide electrode.

16. The method of claim 15, wherein the conductive metal oxide electrode is at least one selected from the group consisting of indium tin oxide, indium zinc oxide, and aluminum zinc oxide.

17. The method of claim 10, wherein the material of the second electrode is at least one selected from the group consisting of Al, Ca, Mg, In, Sn, Mn, Ag, Au and Magnesium alloy.

18. The method of claim 17, wherein the Magnesium alloy included but not limited to Mg:Ag, Mg:In, Mg:Sn, Mg:Sb and Mg:Te.

19. The method of claim 10, wherein the pixel-defining layer and the separator are made of the same kind of material.

20. The method of claim 10, wherein the negative photoresist is polyimide, propylene glycol monomethyl ether acetate, novolak resin, polyhydroxy styrene type resin or the mixture of photoacid generator and crosslinking agent.
